(19) United States
(12) Patent Application Publication
(10) Pub. No.: US 2024/0418022 A1
(43) Pub. Date: Dec. 19, 2024

(54) SUNSHADE GUIDE ASSEMBLY AND SUNROOF DEVICE

(71) Applicant: AISIN (SUZHOU) TECHNICAL CENTER CO.,LTD., Suzhou (CN)

(72) Inventors: Ryuta FUKADA, Suzhou (CN); Jie Feng ZHANG, Suzhou (CN); Jie ZHENG, Suzhou (CN)

(73) Assignee: AISIN (SUZHOU) TECHNICAL CENTER CO.,LTD., Suzhou (CN)

(21) Appl. No.: 18/402,822

(22) Filed: Jan. 3, 2024

(30) Foreign Application Priority Data
Jun. 15, 2023 (CN) 202321528240.X

(51) Int. Cl. E05D 15/06; B60J 7/00

(52) U.S. Cl. CPC E05D 15/0621; B60J 7/0007; E05Y 2201/708; E05Y 2900/542

(57) ABSTRACT

A sunshade guide assembly and a sunroof device that reduces the size and being easy and convenient to assemble and disassemble are provided. The sunshade guide assembly guides a sunshade to move in an opening and closing direction, and includes a support member fixed to the sunshade and a slider fitted and connected to the support member. A protrusion is provided at a position of the slider corresponding to a positioning opening, and the protrusion is formed into a shape corresponding to the positioning opening. The protrusion is embedded into the positioning opening, so that the support member is fitted and connected to the slider, and the protrusion and the positioning opening are configured such that, in a state in which the protrusion is embedded into the positioning opening, the relative movement of the support member relative to the slider in the opening and closing direction is restricted.

### FIELD OF THE DISCLOSURE

The present disclosure relates to a sunshade guide assembly and a sunroof device equipped with the sunshade guide assembly.

### BACKGROUND

An existing sunroof device for a vehicle is provided with a pair of left and right sunshade guide assemblies that guide an opening and closing operation of a sunshade. The sunshade guide assembly includes a support member fixed to the sunshade and a slider snapped into the support member. A part of each slider in the pair of left and right sunshade guide assemblies respectively stretches into the pair of left and right guide rails of the sunroof device and can slide along the guide rails, and another part of each slider is connected to a side pipe fixed at an end on a closing direction side of the sunshade. The pair of sunshade guide assemblies guide the side pipe and the sunshade to move in the opening and closing direction by sliding along the guide rails.

However, because the support member and the slider of the sunshade guide assembly are fixed by means of snap-in connection, assembly and disassembly between the two is complicated, and the size of the device is increased.

### SUMMARY

The present disclosure is made in view of the above problems, and an objective of the present disclosure is to provide a sunshade guide assembly capable of reducing the size of the device and being easy and convenient to assemble and disassemble, and a sunroof device equipped with the sunshade guide assembly.

One embodiment of the present disclosure relates to a sunshade guide assembly, the sunshade guide assembly guides a sunshade to move in an opening and closing direction, and the sunshade guide assembly includes: a support member fixed to the sunshade; and a slider fitted and connected to the support member, a positioning opening is provided on the support member, a protrusion is provided at a position of the slider corresponding to the positioning opening, and the protrusion is formed into a shape corresponding to the positioning opening, and the protrusion is embedded into the positioning opening, so that the support member is fitted and connected to the slider, and the protrusion and the positioning opening are configured such that, in a state in which the protrusion is embedded into the positioning opening, the relative movement of the support member relative to the slider in the opening and closing direction is restricted.

According to the structure, the protrusion provided on the slider is embedded into the positioning opening provided on the support member, so as to achieve the fitting connection between the support member and the slider. Compared with the snap-in connection by using a positioning snap, the structure of the support member and the slider can be simplified, the overall size of the sunshade guide assembly can be miniaturized, and the slider can be easily assembled and disassembled relative to the support member.

In addition, in the present disclosure, preferably, the protrusion and the positioning opening are configured such that, in a state in which the protrusion is embedded into the positioning opening, the relative movement of the support member relative to the slider in a vehicle width direction is restricted, and the relative movement of the support member relative to the slider in an up and down direction is not restricted.

According to the above configuration, in a state in which the protrusion is embedded into the positioning opening, the relative movement of the support member relative to the slider in the vehicle width direction is restricted, and the relative movement of the support member relative to the slider in the up and down direction is not restricted. Thereby, assembly and disassembly of the slider relative to the support member can be easily performed by hand etc., and assembly and disassembly can be more convenient.

In addition, in the present disclosure, preferably, the support member is formed into a sheet shape.

According to the structure, the support member can be easily manufactured, and the height in the up and down direction can be suppressed, so that the size of the device can be reduced.

In addition, in the present disclosure, preferably, in a state in which the protrusion is embedded into the positioning opening from one side of the support member, the protrusion protrudes from the positioning opening to the other side of the support member.

According to the above structure, compared with a structure that a protrusion does not protrude, it can suppress that the support member falls off from the slider.

In addition, in the present disclosure, preferably, the positioning opening is in a rectangular shape, the protrusion is in a shape of a long plate corresponding to the rectangular shape, and the long side direction of the positioning opening and the long side direction of the protrusion are consistent with the opening and closing direction.

According to the above structure, the long side direction of the rectangular-shaped positioning opening and the long side direction of the long plate-shaped protrusion are consistent with the opening and closing direction of the sunshade. Therefore, while the slider drives the support member to slide, the direction of the mutual stress between the slider and the support member is the long side direction, thereby increasing the stress strength.

In addition, in the present disclosure, preferably, one positioning opening and one protrusion are respectively provided.

According to the structure, assembly and disassembly of the slider relative to the support member can be performed more easily.

Another embodiment of the present disclosure relates to a sunroof device, including: a pair of sunshade guide assemblies; a sunshade, where two sides of one end of a the sunshade in an opening and closing direction are respectively fixed to each of the support members in the pair of sunshade guide assemblies; a side pipe fixed to the one end of the sunshade, and each of the sliders in the pair of sunshade guide assemblies is fixedly connected to the side pipe respectively; and a pair of guide rails, wherein each of the sliders in the pair of sunshade guide assemblies is respectively embedded in the pair of guide rails, and can slide along the guide rails.

According to the above configuration, because the sunroof device includes the sunshade guide assembly above-mentioned, the effect of the sunshade guide assembly can be obtained.

In addition, in the present disclosure, preferably, the slider has a side pipe connecting portion fixedly connected to the side pipe and a guide rail embedding portion embedded in the guide rail, and the protrusion is located on an opening direction side compared with the side pipe connecting portion in the opening and closing direction of the sunshade, and is located on an inner side compared with the guide rail embedding portion in the vehicle width direction.

According to the structure, when the sunshade guide assembly is assembled to the sunroof device, the protrusion can be prevented from interfering with the side pipe and the guide rail.

In addition, in the present disclosure, preferably, the side pipe is provided with an opening facing the opening direction side, and the side pipe connecting portion of the slider extends into the side pipe from the opening and is fixedly connected to the side pipe.

According to the above structure, the side pipe connecting portion of the slider protrudes into the side pipe from the opening of the side pipe. Therefore, the overall height of the sunshade guide assembly and the side pipe can be suppressed, and the overall size of the sunshade guide assembly can be miniaturized.

In addition, in the present disclosure, preferably, the side pipe connecting portion is fixedly connected to the side pipe through a screw.

According to the above structure, the connection strength between the side pipe and the slider is ensured, and disassembly and assembly are convenient.

### BRIEF DESCRIPTION OF THE DRAWINGS

FIG. 1 is a perspective view showing a state in which a sunshade guide assembly is assembled to a sunroof device.

FIG. 2 is a perspective view of the sunshade guide assembly viewed from the bottom in FIG. 1.

FIG. 3 is a perspective view showing the assembled and disassembled support member and slider of the sunshade guide assembly.

### DETAILED DESCRIPTION

Hereinafter, preferred embodiments of the present disclosure will be described with reference to the drawings.

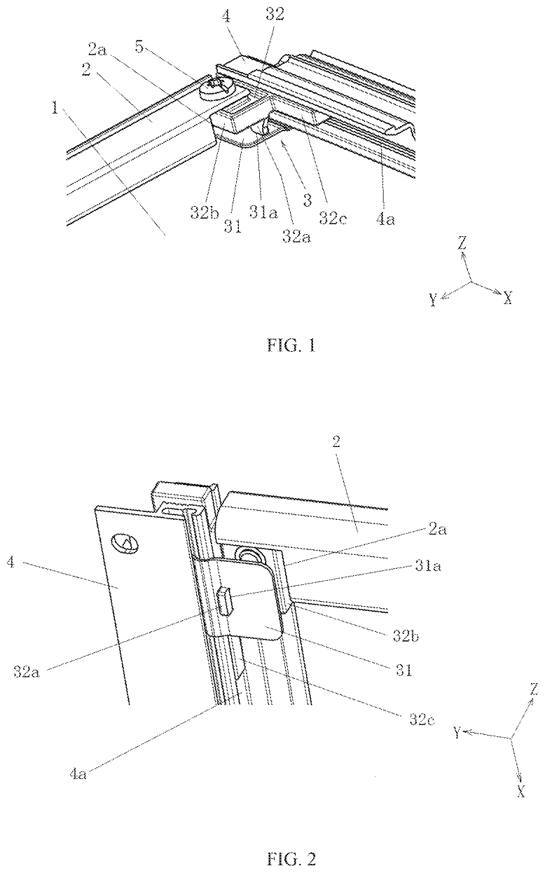

FIG. 1 and FIG. 2 are partial structures of a sunroof device of a vehicle under different angles. FIG. 2 is a perspective view viewed from the bottom of FIG. 1. The direction indicated by X is a front and rear direction of the vehicle, and is also an opening and closing direction of a sunshade, the direction indicated by Y is a left and right direction of the vehicle, that is, a vehicle width direction, and the direction indicated by Z is an up and down direction of the vehicle. The sunroof device includes a pair of sunshade guide assemblies 3, a sunshade 1, a side pipe 2, and a pair of guide rails 4. For convenience, only the structure on one side in the vehicle width direction Y is shown in FIGS. 1 and 2, that is, only one assembly in the pair of sunshade guide assemblies 3 and one guide rail in the pair of guide rails 4 are shown. The structure on the other side in the vehicle width direction Y is similar to this.

The sunshade guide assembly 3 guides the sunshade 1 to move in the opening and closing direction X. The sunshade guide assembly 3 includes a support member 31 and a slider 32.

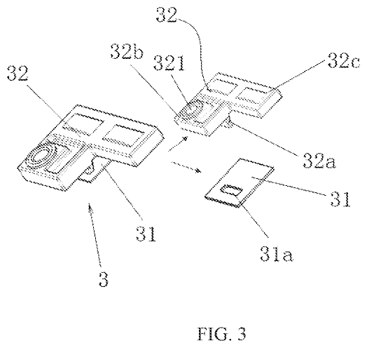

FIG. 3 is a perspective view showing assembled and disassembled support member and slider of the sunshade guide assembly. As shown in FIG. 3, the support member 31 is formed into a sheet shape. The sheet shape does not strictly refer to a flat plate shape, but also includes a thin plate shape with a degree of curvature or curved portions. In addition, the support member 31 is made of an elastic material such as resin.

One positioning opening 31a is provided on the support member 31, and the positioning opening 31a has a rectangular shape. The support member 31 is fixed to the sunshade 1 by sewing, adhesive bonding, welding and the like.

The slider 32 is fitted and connected to the support member 31. The slider 32 includes one protrusion 32a, a side pipe connecting portion 32b fixedly connected to the side pipe 2, and a guide rail embedding portion 32c embedded in the guide rail 4.

The protrusion 32a is provided at a position of the slider 32 corresponding to the positioning opening 31a of the support member 31, and the protrusion 32a is formed into a long plate shape corresponding to the rectangular shape of the positioning opening 31a of the support member 31. The protrusion 32a is located on an opening-direction side compared with the side pipe connecting portion 32b in the opening and closing direction X of the sunshade 1, and is located on an inner side compared with the guide rail embedding portion 32c in the vehicle width direction Y.

A threaded hole 321 is provided in the side pipe connecting portion 32b, and a screw 5 described later is screwed into the threaded hole 321.

Next, the fitting connection between the support member 31 and the slider 32 of the sunshade guide assembly 3 is described.

The protrusion 32a of the slider 32 is embedded into the positioning opening 31a of the support member 31 from one side of the support member 31 (in this embodiment, an upper side in the up and down direction Z), so that the support member 31 is fitted and connected to the slider 32. In this fitted state, the protrusion 32a protrudes from the positioning opening 31a to the other side (in this embodiment, a lower side in the up and down direction Z) of the support member 31 (see FIG. 2). The size of the protrusion 32a is designed such that, in a state in which the protrusion 32a is embedded into the positioning opening 31a, the relative movement of the support member 31 relative to the slider 32 in the opening and closing direction X and the vehicle width direction Y is restricted. In addition, preferably, the relative movement of the support member 31 relative to the slider 32 in the up and down direction Z is not restricted. Through such a structure, the support member 31 can be easily separated from the slider 32 with a tool, a hand, or the like.

Next, the connection between the sunshade guide assembly 3 and the side pipe 2 and the guide rail 4 is described.

The side pipe 2 is fixed at one end of the sunshade 1 in the opening and closing direction X. Two sides of one end of the sunshade 1 in the opening and closing direction X are respectively fixed to each support member 31 in the pair of sunshade guide assemblies 3. The long side direction of the positioning opening 31a of the support member 31 is consistent with the opening and closing direction X of the sunshade 1. And correspondingly, the long side direction of the protrusion 32a of the slider 32 is also consistent with the opening and closing direction X of the sunshade 1.

Each slider 32 in the pair of sunshade guide assemblies 3 is fixedly connected to the side pipe 2 respectively. Specifically, the side pipe 2 is provided with an opening 2a facing the opening-direction side in the opening and closing direction X of the sunshade 1, and the side pipe connecting portion 32b of the slider 32 extends into the side pipe 2 from the opening 2a. The screw 5 is inserted through a hole on the side pipe 2 and screwed into the threaded hole 321 provided in the side pipe connecting portion 32b, so that the side pipe connecting portion 32b is fixed relative to the side pipe 2.

Each slider 32 in the pair of sunshade guide assemblies 3 is respectively embedded in slider rails 4a of the pair of guide rails 4, and can slide along the guide rails 4. When each slider 32 in the pair of sunshade guide assemblies 3 slides along the pair of guide rails 4 respectively, the slider 32 drives the side pipe 2 to move together to open and close the sunshade 1.

Next, effects of the present embodiment are described.

The positioning opening 31a is provided on the support member 31, and the protrusion 32a is provided on the slider 32, and the protrusion 32a is embedded into the positioning opening 31a, so that the support member 31 is fitted and connected to the slider 32. Therefore, compared with a situation in which the snap-in connection is performed by using a positioning snap, the structure of the support member 31 and the slider 32 can be simplified, the overall size of the sunshade guide assembly 3 can be miniaturized, and assembly and disassembly of the slider 32 relative to the support member 31 can be easily performed.

The protrusion 32a and the positioning opening 31a are configured so that, in a state in which the protrusion 32a is embedded into the positioning opening 31a, the relative movement of the support member 31 relative to the slider 32 in the vehicle width direction Y is restricted, and the relative movement of the support member 31 relative to the slider 32 in the up and down direction Z is not restricted. Thereby, assembly and disassembly of the slider 32 relative to the support member 31 can be easily performed by hand or other meaning, making the assembly and disassembly more convenient.

Because the support member 31 is formed into a sheet shape, the support member 31 can be easily manufactured from a sheet or the like, and the height in the up and down direction can be suppressed, achieving miniaturization of the device.

The protrusion 32a is embedded into the positioning opening 31a from one side of the support member 31 and protrudes toward the other side of the support member 31. Therefore, compared with a structure in which the protrusion does not protrude, the support member 31 can be suppressed from falling off from the slider 32.

In this embodiment, the long side direction of the rectangular-shaped positioning opening 31a and the long side direction of the long plate-shaped protrusion 32a are consistent with the opening and closing direction X of the sunshade 1. Therefore, while the slider 32 drives the support member 31 to slide along the opening and closing direction X of the sunshade 1, the direction of mutual stress between the slider 32 and the support member 31 is the long side direction, so that the stress strength is improved.

The support member 31 is provided with one positioning opening 31a, so that the slider 32 can be further easily assembled and disassembled relative to the support member 31.

The protrusion 32a is located on the opening direction side compared with the side pipe connecting portion 32b fixedly connected to the side pipe 2 in the opening and closing direction X of the sunshade 1, and is located on the inner side compared with the guide rail embedding portion 32c embedded in the guide rail 4 in the vehicle width direction Y. Therefore, when the sunshade guide assembly 3 is assembled to the sunroof device, the protrusion 32a can be prevented from interfering with the side pipe 2 and the guide rail 4.

The side pipe connecting portion 32b of the slider 32 protrudes into the side pipe 2 from the opening 2a of the side pipe 2. Therefore, the overall height of the sunshade guide assembly 3 and the side pipe 2 can be suppressed, and the overall size of the sunshade guide assembly 3 can be miniaturized.

The slider 32 is fixedly connected to the side pipe 2 through the screw 5, so that the connection strength between the side pipe 2 and the slider 32 is ensured, and it is convenient to perform disassembly and assembly.

As mentioned above, although the preferred embodiment of the present disclosure is described, the present disclosure is not limited to this. Various changes can be made as follows.

In the preferred embodiment described above, the protrusion 32a and the positioning opening 31a are configured so that, in a state in which the protrusion 32a is embedded into the positioning opening 31a, the relative movement of the support member 31 relative to the slider 32 in the opening and closing direction X and the vehicle width direction Y is restricted, and the relative movement of the support member 31 relative to the slider 32 in the up and down direction Z is not restricted, but no limitation is set thereto, provided that the slider 32 can smoothly drive the support member 31 to move in the opening and closing direction X of the sunshade 1, that is, provided that the relative movement of the support member 31 relative to the slider 32 in the opening and closing direction X of the sunshade 1 is restricted.

In addition, in the preferred embodiment, the support member 31 is formed into a sheet shape, but is not limited thereto. For example, the support member 31 may also be in the shape of a block with a certain thickness.

In addition, as long as the slider 32 can smoothly drive the support member 31 to move in the opening and closing direction of the sunshade 1, the protrusion 32a of the slider 32 may not protrude from the positioning opening 31a of the support member 31 to the other side of the support member 31.

In the above preferred embodiment, the positioning opening 31a has a rectangular shape, but the shape of the positioning opening 31a is not limited thereto. For example, the positioning opening 31a may also be a circle, a polygonal shape such as a triangle and a trapezoid. Correspondingly, the protrusion 32a of the slider 32 may be formed into a shape corresponding to the positioning opening 31a.

In the above preferred embodiment, the long side direction of the rectangular-shaped positioning opening 31a and the long side direction of the long plate-shaped protrusion 32a are consistent with the opening and closing direction X of the sunshade 1, but no limitation is set thereto. As long as the strength in the force receiving direction of the protrusion 32a and the support member 31 can be ensured, there is no limit on the long side direction of the protrusion 32a and the positioning opening 31a.

In addition, in the above preferred embodiment, one positioning opening 31a is provided, but a plurality of positioning openings may be provided as necessary. Correspondingly, a plurality of protrusions 32a on the slider 32 may also be provided.

In the above preferred embodiment, the protrusion 32a is located on the opening-direction side compared with the side pipe connecting portion 32b in the opening and closing direction X of the sunshade 1, and is located on the inner side compared with the guide rail embedding portion 32c in the vehicle width direction Y, but no limitation is set thereto. As long as the normal operation of the sunshade guide assembly 3 is not affected, the positional relationship of the protrusion, the side pipe connecting portion and the guide rail embedding portion in the slider 32 is not particularly limited.

In the above preferred embodiment, the side pipe connecting portion 32b of the slider 32 protrudes into the side pipe 2 from the opening 2a and is fixedly connected to the side pipe 2, but no limitation is set thereto. For example, the side pipe connecting portion 32b of the slider 32 may be wrapped around the side pipe 2. In this case, a snap can be provided on the side pipe connecting portion 32b of the slider 32, and a protrusion is provided at a corresponding position on a outer surface of the side pipe 2, and the slider 32 is fixedly connected to the side pipe 2 through the snap-in connection between the snap and the protrusion.

In addition, when the side pipe connecting portion 32b of the slider 32 extends into the side pipe 2 from the opening 2a and is fixedly connected to the side pipe 2, the slider 32 and the side pipe 2 can also be fixedly connected by means of pin riveting or the like. Fixedly connections are not limited by using screws.

In addition, the sunshade guide assembly of the present disclosure is not limited to a sunroof device of a vehicle, and may be applied to a sunroof of a house or the like.

As described above, the embodiments of this present disclosure are described. However, the present disclosure is not limited to the above embodiments. Without departing from the gist of the present disclosure, embodiments obtained by the person skilled in the art by appropriately changing, combining, and deleting the above constituent elements are also included in the technical scope to be protected by the present disclosure.

### REFERENCE SIGNS LIST

1 Sunshade
2 Side pipe
2a Opening
3 Sunshade guide assembly
4 Guide rail
4a Slider rail
5 Screw
31 Support member
31a Positioning opening
32 Slider
32a Protrusion
32b Side pipe connecting portion
32c (Guide rail embedding portion

1. A sunshade guide assembly that guides a sunshade to move in an opening and closing direction, comprising:
a support member fixed to the sunshade; and
a slider fitted and connected to the support member,
a positioning opening is provided on the support member,
a protrusion is provided at a position of the slider corresponding to the positioning opening, and the protrusion is formed into a shape corresponding to the positioning opening, and
the protrusion is embedded into the positioning opening, so that the support member is fitted and connected to the slider, and the protrusion and the positioning opening are configured such that, in a state in which the protrusion is embedded into the positioning opening, the relative movement of the support member relative to the slider in the opening and closing direction is restricted.

2. The sunshade guide assembly according to claim 1, wherein:
the protrusion and the positioning opening are configured such that, in a state in which the protrusion is embedded into the positioning opening, the relative movement of the support member relative to the slider in a vehicle width direction is restricted, and the relative movement of the support member relative to the slider in an up and down direction is not restricted.

3. The sunshade guide assembly according to claim 1, wherein,
the support member is formed into a sheet shape.

4. The sunshade guide assembly according to claim 3, wherein:
in a state in which the protrusion is embedded into the positioning opening from one side of the support member, the protrusion protrudes from the positioning opening to the other side of the support member.

5. The sunshade guide assembly according to claim 3, wherein:
the positioning opening is in a rectangular shape, the protrusion is in a shape of a long plate corresponding to the rectangular shape, and the long side direction of the positioning opening and the long side direction of the protrusion are consistent with the opening and closing direction.

6. The sunshade guide assembly according to claim 1, wherein:
one positioning opening and one protrusion are respectively provided.

7. A sunroof device, comprising:
a pair of sunshade guide assemblies according to claim 1;
a sunshade, wherein two sides of one end of the sunshade in an opening and closing direction are respectively fixed to each of the support members in the pair of sunshade guide assemblies;
a side pipe fixed to the one end of the sunshade, and each of the sliders in the pair of sunshade guide assemblies is fixedly connected to the side pipe respectively; and
a pair of guide rails, wherein each of the sliders in the pair of sunshade guide assemblies is respectively embedded in the pair of guide rails, and can slide along the guide rails.

8. The sunroof device according to claim 7, wherein
the slider has a side pipe connection portion fixedly connected to the side pipe and a guide rail embedding portion embedded in the guide rail, and the protrusion is located on an opening direction side compared with the side pipe connecting portion in the opening and closing direction of the sunshade, and is located on an inner side compared with the guide rail embedding portion in a vehicle width direction.

9. The sunroof device according to claim 8, wherein
the side pipe is provided with an opening facing the opening direction side, and the side pipe connecting portion of the slider extends into the side pipe from the opening and is fixedly connected to the side pipe.

10. The sunroof device according to claim 9, wherein
the side pipe connecting portion is fixedly connected to the side pipe through a screw.
